(19) United States
(12) Patent Application Publication
(10) Pub. No.: US 2011/0002137 A1
(43) Pub. Date: Jan. 6, 2011

(54) LIGHT EMITTING MODULE AND AUTOMOTIVE LAMP

(75) Inventors: Hitoshi TAKEDA, Shizuoka (JP); Tsukasa TOKIDA, Shizuoka (JP)

Correspondence Address: FULWIDER PATTON LLP, HOWARD HUGHES CENTER, 6060 CENTER DRIVE, TENTH FLOOR, LOS ANGELES, CA, 90045, US

(73) Assignee: KOITO MANUFACTURING CO., LTD., Tokyo (JP)

(21) Appl. No.: 12/829,848

(22) Filed: Jul. 2, 2010

(30) Foreign Application Priority Data
Jul. 3, 2009 (JP) 2009-158645

(51) Int. Cl. F21V 29/00; H01J 1/62

(52) U.S. Cl. 362/549; 313/501

(57) ABSTRACT

A light emitting module includes a light emitting element, and a phosphor configured to emit visible light after being excited by the light emitted by the light emitting element. The light emitting element is structured such that the peak wavelength of the light, emitted by the light emitting element immediately after the start of an operation of the light emitting element, is shorter than that of an excitation spectrum for the phosphor, and the peak wavelength of the light emitted by the light emitting element is shifted toward that of the excitation spectrum for the phosphor with an increase in the temperature of the element due to its operation.

### CROSS-REFERENCE TO RELATED APPLICATION

This application is based upon and claims the benefit of priority from the prior Japanese Patent Application No. 2009-158645, filed on Jul. 3, 2009, the entire content of which is incorporated herein by reference.

### BACKGROUND OF THE INVENTION

1. Field of the Invention

The present invention relates to a light emitting module and an automotive lamp used in an automobile, etc.

2. Description of the Related Art

Recently, for the purpose of long life or reduction in power consumption, a technique has been developed in which a light emitting module having a light emitting element, such as an LED (Light Emitting Diode), is used as a light source for emitting strong light, such as a lamp unit that emits light toward the front of a vehicle and various light fittings, etc.

However, because it is demanded that a light emitting module used in such applications emits light with high luminous intensity, a large current is to be applied while emitting light. Accordingly, there is the problem that a large amount of heat is generated centered on an light emitting element, thereby raising the temperature of the whole light emitting module. Then, various techniques for suppressing an increase in the temperature of a light emitting module have been devised. For example, Japanese Patent Application Publication No. 2006-335328 discloses an automotive headlamp in which a radiating fin is provided in a metal support member for supporting a plurality of lamp units.

An automotive lamp comprising an light emitting module is sometimes specified with respect to its maximum and minimum luminous intensity, depending on a specification. Because the light emitting characteristics of a light emitting module, including brightness, are temperature dependent, there is a tendency in which the brightness of a light emitting module is decreased as the temperature of the light emitting module is raised with a lapse of time from immediately after the start of lighting. Accordingly, a device for increasing the radiation performance including the aforementioned radiating fin is to be adopted in a light emitting module; however, it is difficult to completely eliminate an increase in the temperature.

### SUMMARY OF THE INVENTION

The present invention has been made in view of these situations, and a purpose of the invention is to provide a light emitting module in which a change in the brightness during lighting is suppressed and an automotive lamp comprising the light emitting module.

In order to solve the aforementioned problem, a light emitting module according to an embodiment of the present invention comprises a light emitting element and a phosphor configured to emit visible light after being excited with the light emitted by the light emitting element. The light emitting element is structured such that the peak wavelength of the light, emitted by the light emitting element immediately after the start of an operation of the light emitting element, is shorter than that of an excitation spectrum for the phosphor, and the peak wavelength of the light emitted by the light emitting element is shifted toward that of the excitation spectrum for the phosphor with an increase in the temperature of the element due to its operation.

According to the embodiment, even if the emission intensity of the phosphor itself is decreased with an increase in the temperature, the peak wavelength of the light emitted by the light emitting element is shifted toward that of the excitation spectrum for the phosphor, with the increase in the temperature. A shift of the peak wavelength of the light emitted by such a light emitting element makes the emission intensity of a phosphor higher. Accordingly, a decrease in the emission intensity resulting from the deterioration in the performance of a phosphor itself due to an increase in the temperature, and an increase in the emission intensity resulting from approximation of the wavelength of the light for exciting the phosphor to the peak wavelength of the excitation spectrum, will be balanced with each other. As a result, a change in the brightness during lighting of a light emitting module, for example, a change in the brightness from immediately after lighting until the temperature of the module is stabilized, can be suppressed.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is a cross-sectional view illustrating the structure of an automotive headlamp according to the present embodiment;

FIG. 2 is a cross-sectional view illustrating the structure of a light emitting device according to the present embodiment;

FIG. 3 is a graph illustrating the relationship between the brightness and the temperature in a white light emitting module in which a blue LED and a yellow phosphor are combined;

FIG. 4 is a graph illustrating changes in the brightness relative to time from the start of lighting, in an automotive lamp comprising the light emitting module, the junction temperature of which becomes approximately 100° C. in a thermal saturation state

FIG. 5 is a graph illustrating an example of an excitation spectrum for the yellow phosphor;

FIG. 6 is a graph illustrating the temperature dependence of the peak wavelength of the light emitted by the blue LED chip;

FIG. 7 is a graph illustrating the temperature dependence of the beam emitted by the single blue LED chip;

FIG. 8 is a graph in which, of the emission spectrum illustrated in FIG. 5, the emission spectrum in a region where the wave length is approximately 450 nm is enlarged; and

FIG. 9 is a graph illustrating changes in the brightness relative to time from the start of lighting, in the light emitting module according to the present embodiment.

### DETAILED DESCRIPTION OF THE INVENTION

The invention will now be described by reference to the preferred embodiments. This does not intend to limit the scope of the present invention, but to exemplify the invention.

Hereinafter, embodiments of the present invention will be described in detail with reference to the drawings. In the descriptions of the drawings, like elements will de denoted with like reference numerals and duplicative descriptions will be appropriately omitted.

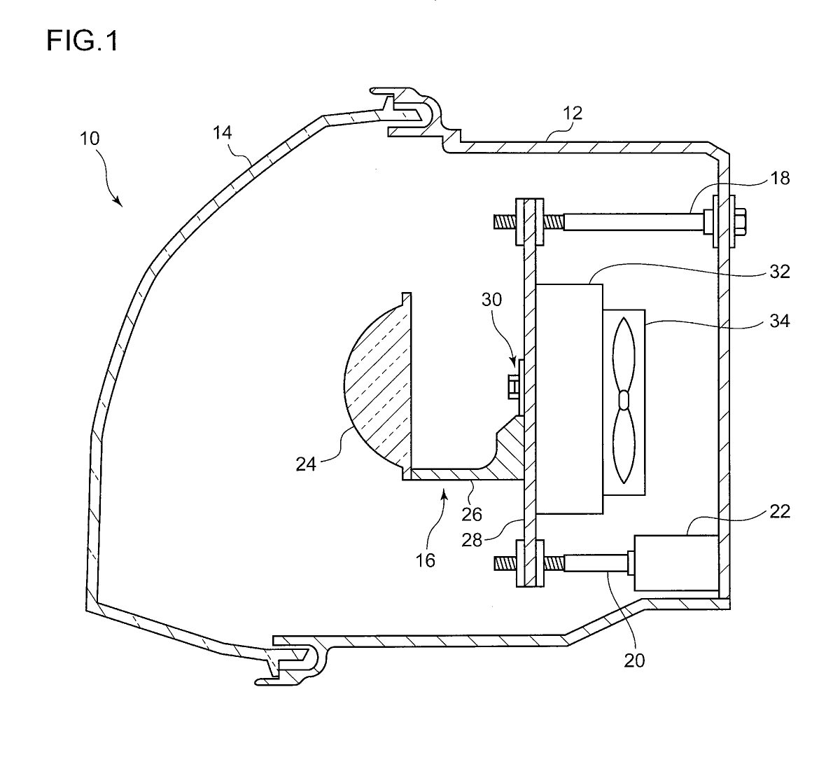

FIG. 1 is a cross-sectional view illustrating the structure of an automotive headlamp 10 according to the present embodiment. The automotive headlamp 10 comprises a lamp body 12, a front cover 14, and a lamp unit 16. Hereinafter, descriptions will be made assuming that, in FIG. 1, the side of the front cover 14 is the lamp front and the side of the lamp body 12 is the lamp back. Further, it is assumed that, when viewing the direction toward the front cover 14 (the lamp front) from a light source, which will be described later, the right side is the lamp right side and the left side is the lamp left side. FIG. 1 illustrates, when viewed from the lamp left side, the cross section of the automotive headlamp 10 that is cut by a vertical plane including the light axis of the lamp unit 16. When installing the automotive headlamps 10 in a vehicle, two automotive headlamps 10, both of which are formed symmetrically to each other, are provided in each of the left front and the right front of the vehicle, respectively. FIG. 1 illustrates the structure of either of the two automotive headlamps 10.

The lamp body 12 is formed into a box shape with an opening. The front cover 14 is formed into a bowl shape with a resin or glass having translucency. The edge of the front cover 14 is fixed to the opening of the lamp body 12. Thus, a lamp chamber is formed in the area covered with the lamp body 12 and the front cover 14.

A lamp unit 16 is arranged in the lamp chamber. The lamp unit 16 is fixed to the lamp body 12 with aiming screws 18 and 20. The aiming screw 20, located at a lower position, is configured to be rotated by the operation of a leveling actuator 22. Accordingly, it is possible that the light axis of the lamp unit 16 is transferred in the vertical direction by operating the leveling actuator 22.

The lamp unit 16 has a projection lens 24, a support member 26, a bracket 28, a light emitting device 30, a radiating fin 32, and a radiating fan 34. The projection lens 24 is composed of a plano-convex aspheric lens, the surface on the lamp front side of which is convex-shaped and that on the lamp back side of which is flat-shaped, and the projection lens 24 projects, as an inverted image, the image of the light source that is formed on the back focal plane into the lamp front direction. The support member 26 supports the projection lens 24. The light emitting device 30 is provided with a light emitting module 36. The projection lens 24 functions as an optical member that collects the light emitted by the light emitting module 36 toward the lamp front direction. The radiating fin 32 is fixed to the surface on the back side of the bracket 28, and the radiating fan 34 is provided on the back side of the radiating fin 32. The radiating fin 32 and the radiating fan 34 radiate the heat emitted mainly by the light emitting module 36.

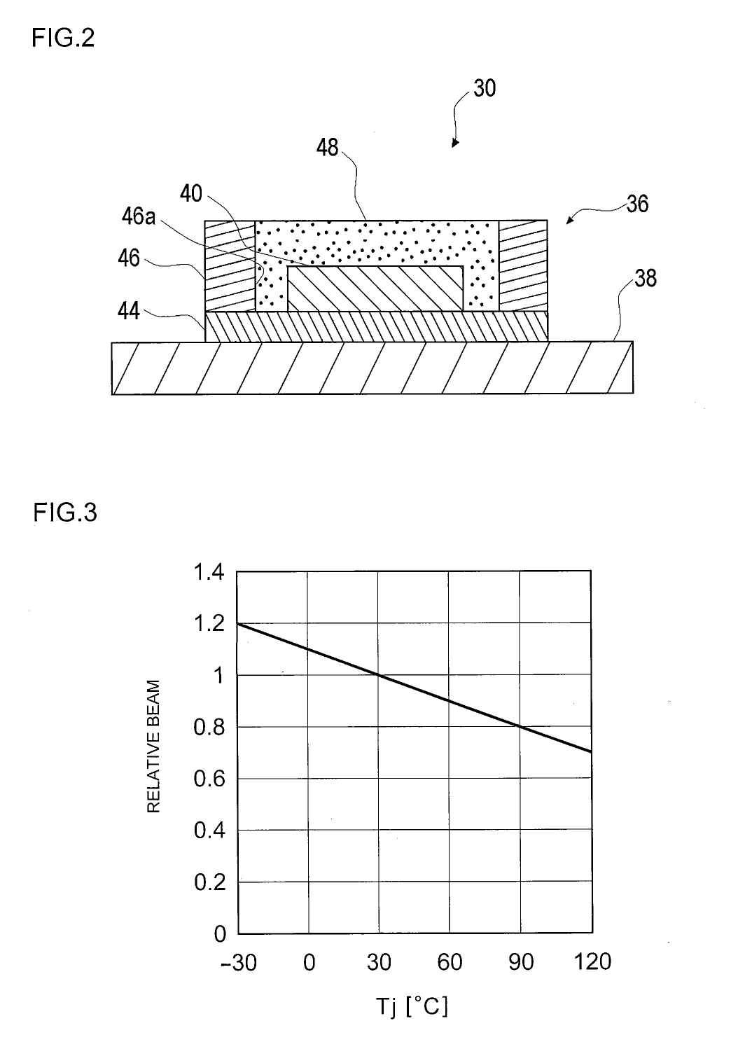

FIG. 2 is a cross-sectional view illustrating the structure of the light emitting device 30 according to the present embodiment. The light emitting device 30 has the light emitting module 36 and a substrate 38. The substrate 38 is a printed circuit board, to the upper surface of which the light emitting module 36 is fixed. The light emitting module 36 has a device mounting substrate 44, a reflective substrate 46, a semiconductor light emitting element 40, and a phosphor layer 48. In the light emitting module 36 according to the present embodiment, the phosphor layer 48 covers the light-emitting surface of the semiconductor light emitting element 40 so as to seal the semiconductor light emitting element 40.

The device mounting substrate 44 is formed into a plate shape with a material having high thermal conductivity, such as AlN, SiC, Al2O3, and Si, etc. The reflective substrate 46 is formed into a shape in which a through-hole 46a is provided at the center of the rectangular parallelepiped shaped member. The inner surface of the through-hole 46a is subjected to mirror surface processing in which aluminum or silver is deposited or sputtered thereon in order to reflect light.

The semiconductor light emitting element 40 is composed of an LED element or an LD element, both of which emit ultraviolet light or visible light with a short wavelength. In the present embodiment, a blue LED, which emits mainly the light with a blue wavelength, is used as the semiconductor light emitting element 40. Specifically, the semiconductor light emitting element 40 is composed of an InGaN LED element, which is formed with an InGaN semiconductor layer being subjected to crystal growth on a sapphire substrate. The emission wavelength region of an InGaN-based compound semiconductor varies depending on an In content. For example, when an In content is high, the emission wavelength becomes longer, in contrast when an In content is low, the emission wavelength becomes shorter. Accordingly, a semiconductor element emitting light with a desired wavelength can be obtained by varying an In content.

The semiconductor light emitting element 40 is formed as, for example, a chip of a size of 1 mm square, and is structured such that the central wavelength of the blue light, which is emitted therefrom, is approximately 450 nm. It is needless to say that the structure of the semiconductor light emitting element 40 and the wavelength of the light emitted therefrom shall not be limited to those stated above.

In the phosphor layer 48, a yellow phosphor is sealed by a binder member in a film (layer) shape covering the upper surface of the semiconductor light emitting element 40. Herein, a known yellow phosphor may be appropriately selected as the yellow phosphor. It is more preferable that an excitation spectrum for the yellow phosphor includes the peak wavelength of the blue light emitted from the aforementioned semiconductor light emitting element 40.

The phosphor layer 48 is formed by, for example, applying a phosphor paste, which has been produced by mixing a phosphor into a liquid or gelled binder, to the upper surface of the semiconductor light emitting element 40, thereafter by curing the binder in the phosphor paste. For example, a silicone resin or a fluorine resin, etc., can be used as the binder. Because the light emitting device according to the present embodiment uses ultraviolet light or visible light with a short wavelength as an excitation light source, a binder excellent in the resistance to the ultraviolet light is preferred.

The phosphor layer 48 may contain, other than a phosphor, a substance having various physical properties. The index of refraction of the phosphor layer 48 can be enhanced by mixing, into the phosphor layer 48, a substance having an index of refraction higher than that of the binder, for example, a metal oxide, a fluorine compound, a sulfide, etc. Thereby, the total reflection occurring when the light emitted from the semiconductor light emitting element 40 enters the phosphor layer 48, is reduced and therefore an effect can be obtained in which the efficiency at which the excitation light is taken into the phosphor layer 48 is improved. Further, the index of refraction can be enhanced by making the particle size of the substance to be mixed into the phosphor layer 48 nano-sized, without decreasing the transparency of the phosphor layer 48. Also, white powder of alumina, zirconia, or titanium oxide, etc., with an average particle size of approximately 0.3 to 3 μm, can be mixed into the phosphor layer 48 as a light-scattering agent. Thereby, uniformity in the luminance or chromaticity within the light-emitting surface can be prevented.

The phosphor layer 48 emits yellow light after converting the wavelength of the blue light mainly emitted by the semiconductor light emitting element 40. Accordingly, synthesized light in which the blue light that has been transmitted, as it is, through the phosphor layer 48 and the yellow light whose wavelength has been converted by the phosphor layer 48, are combined, is emitted from the light emitting module 36. Thus, it becomes possible that the light emitting module 36 will emit white light.

A light emitting element mainly emitting the light with a wavelength other than blue may be adopted as the semiconductor light emitting element 40. Also, in this case, a substance for converting the wavelength of the light mainly emitted by the semiconductor light emitting element 40 is adopted in the phosphor layer 48. Also, in this case, the phosphor layer 48 may convert the wavelength of the light emitted by the semiconductor light emitting element 40 such that the light with a wavelength of white or close to white is emitted by combining with the light with the wavelength mainly emitted by the semiconductor light emitting element 40. For example, a light emitting module provided with a semiconductor light emitting element, emitting blue light, and a phosphor layer, containing more than two types of phosphor by which the wavelengths of the light emitted by the semiconductor light emitting element are respectively converted into red and green, may be adopted. Alternatively, a light emitting module provided with a semiconductor light emitting element, emitting ultraviolet light, and a phosphor layer, containing more than three types of phosphor by which the wavelengths of the light emitted by the semiconductor light emitting element are respectively converted into blue, red, and green, may be adopted.

The brightness of a light emitting module in which the aforementioned LED and phosphor are combined with each other is temperature dependent. FIG. 3 is a graph illustrating the relationship between the brightness and the temperature in a white light emitting module in which a blue LED and a yellow phosphor are combined. The horizontal axis illustrated in FIG. 3 represents the junction temperature (Tj), which is a temperature of the LED chip, and the vertical axis represents the relative beam obtained by assuming that the beam occurring when the junction temperature is 25° C. is 1.

It can be learned that the relative beam, i.e., the brightness of a light emitting module is decreased as the junction temperature becomes higher, as illustrated in FIG. 3. The temperature dependence of a phosphor can be cited as a factor of such a decrease in the brightness.

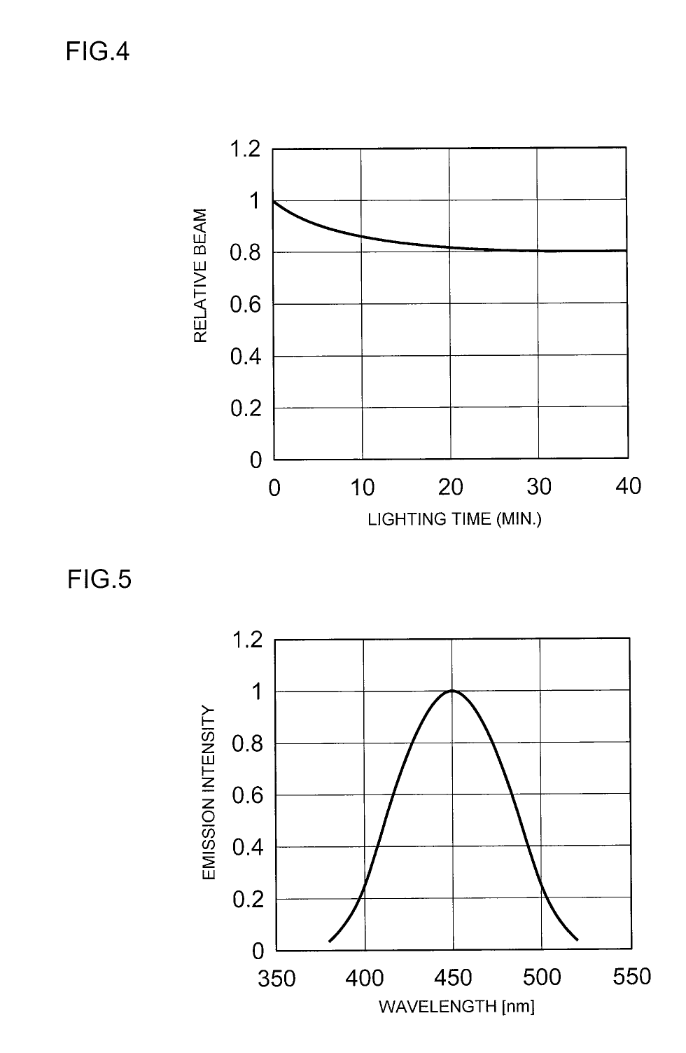

Accordingly, when an LED is driven with a constant current, the junction temperature of the light emitting module including the LED is raised due to self-heating from immediately after lighting. And, the brightness of the light emitting module is continuing to be deceased before the temperature is stabilized in an equilibrium state. FIG. 4 is a graph illustrating changes in the brightness relative to time from the start of lighting, in an automotive lamp comprising the light emitting module, the junction temperature of which becomes approximately 100° C. in a thermal saturation state. As illustrated in FIG. 4, the brightness is decreased from immediately after lighting and is finally stabilized after a lapse of approximately 30 minutes.

Such a phenomenon is observed across current white LEDs. Accordingly, when using such a light emitting module in an automotive lamp, it is needed to design a light emitting module such that the light emitting module satisfies a predetermined light-distribution specification in view of these phenomena. In order to confirm whether a light-distribution specification will be saturated, the luminous intensity immediately after lighting and that in the thermal saturation state are usually taken as the maximum and minimum luminous intensity, respectively. Accordingly, as a difference between the luminous intensity immediately after lighting of a light emitting module and that in the thermal saturation state is larger, it becomes difficult that both the maximum and minimum luminous intensity will satisfy a light-distribution specification, possibly causing the degree of freedom in designing an automotive lamp or the yield in production to be deteriorated.

In the course of intensive study in such a situation, the present inventors have considered the possibility that a difference between the maximum and minimum luminous intensity of a light emitting module can be suppressed by optimizing the peak wavelength of the light emitted by a semiconductor light emitting element in view of the temperature dependence and excitation wavelength dependence of the emission intensity of a phosphor.

FIG. 5 is a graph illustrating an example of the excitation spectrum for a yellow phosphor. As illustrated in FIG. 5, the emission intensity of a phosphor is dependent on the emission wavelength of an excitation light source, other than the aforementioned temperature dependence. In the phosphor illustrated in FIG. 5, the emission intensity is highest when the wavelength of an excitation light source is 450 nm, and is decreased as the wavelength thereof is away from 450 nm. Accordingly, when combining a phosphor and an LED, it is common to select an LED with an emission wavelength suitable for an excitation spectrum for the phosphor such that the emission efficiency as a light emitting module becomes highest. Accordingly, in the phosphor in FIG. 3, the highest emission efficiency can be obtained when the peak wavelength of the emission spectrum of an LED is 450 nm.

In addition, it is common that beam data of various LED products are described on their data sheets when Tj is 25° C. In power LEDs, the junction temperatures Tj particularly vary greatly depending on the difference in the radiation structures in accordance with the difference in user's applications or types of product. Therefore, the beam cannot be unambiguously and simply specified in many cases. Accordingly, the beam occurring when Tj is 25° C. is used, which demonstrates that the beam is not affected by heat.

Due to the aforementioned circumstances, the beam occurring when Tj is 25° C. is regarded as the top priority, and therefore the peak wavelength of the light emitted by an LED when Tj is 25° C. is set to 450 nm at which the emission intensity of the excitation spectrum for a phosphor is highest. However, the peak wavelength of the light emitted by an LED has a tendency of being shifted toward longer wavelength due to heat, and therefore the emission intensity of a phosphor exhibits a declining tendency with an increase in Tj, as illustrated in FIG. 3. That is, the brightness of an light emitting module exhibits a declining tendency with an increase in the temperature.

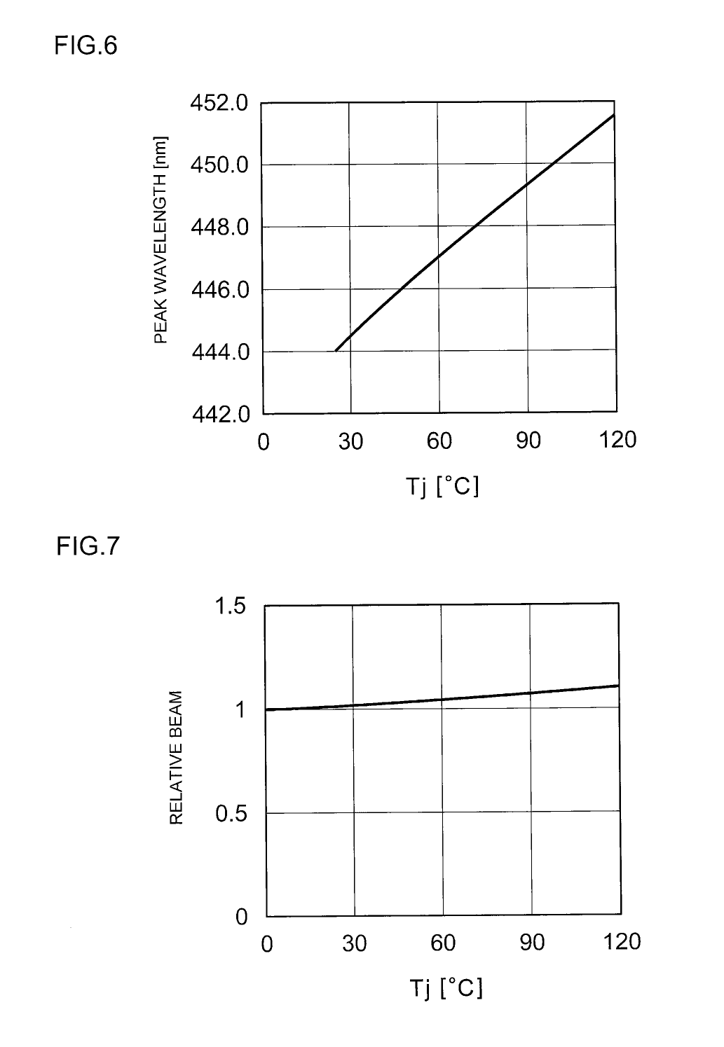

FIG. 6 is a graph illustrating the temperature dependence of the peak wavelength of the light emitted by the blue LED chip. As illustrated in FIG. 6, the peak wavelength of the light emitted by an LED is shifted toward longer wavelength as the junction temperature Tj is raised. FIG. 7 is a graph illustrating the temperature dependence of the beam emitted by the single blue LED chip. A light output itself of an LED chip is decreased due to an increase in Tj; however the relative visibility is conversely improved due to the shift of the peak wavelength toward longer wavelength, thereby the beam exhibiting an increasing tendency within this wavelength range.

From the aforementioned knowledge, the present inventors have considered the following structure. That is, the peak wavelength of the emission spectrum of an LED, the emission spectrum occurring when Tj is the maximum expected during the use of a product or an application, is determined so as to match the excitation spectrum for which the emission intensity of a phosphor becomes the maximum, without setting the peak wavelength of the light emitted by an LED when Tj is 25° C. such that the emission intensity of a phosphor becomes the maximum, as done in a current light emitting module including an LED.

Specifically, a case of a light emitting module in which a phosphor having a characteristic illustrated in FIG. 5 and a blue LED, the light emitted by which has a peak wavelength of 450 nm when Tj is 100° C. as illustrated in FIG. 6, are used and the expected maximum Tj is assumed to be 100° C., will be described.

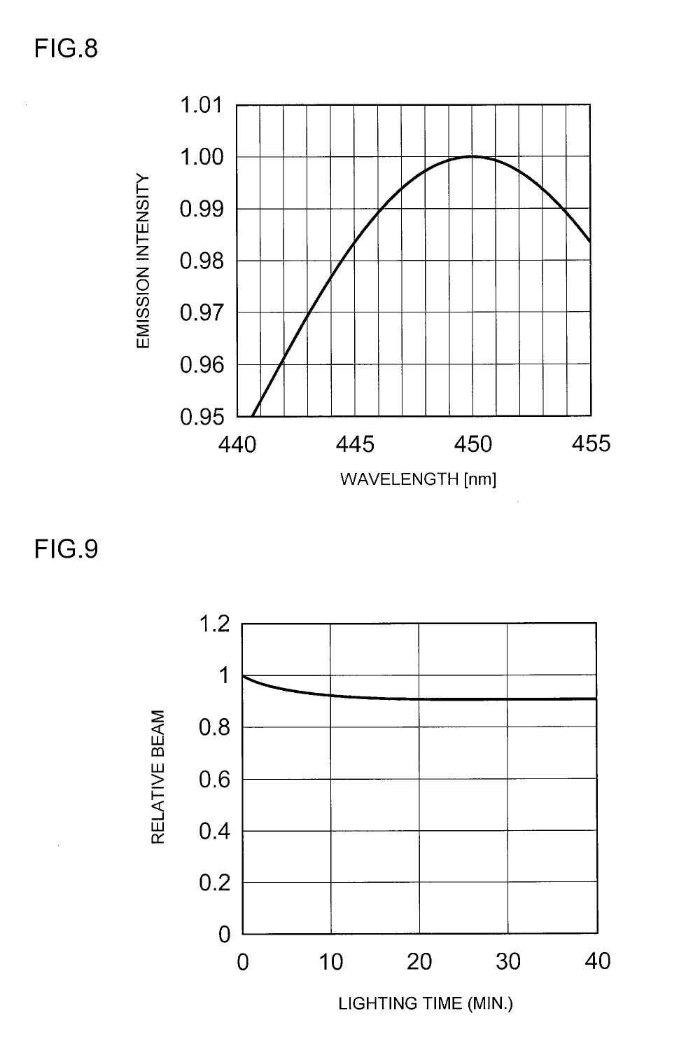

FIG. 8 is a graph in which, of the emission spectrum illustrated in FIG. 5, the emission spectrum in the region of the wave length of approximately 450 nm is enlarged. In setting the peak wavelength of such a blue LED illustrated in FIG. 6, the peak wavelength of the blue LED, occurring when Tj is 25° C., becomes approximately 444 nm. This peak wavelength is shorter than the excitation wavelength of 450 nm for which the emission intensity of a yellow phosphor becomes the maximum. Accordingly, the emission intensity of a yellow phosphor excited by the light with the peak wavelength of 444 nm is more decreased than that of a yellow phosphor excited by the light with the peak wavelength of 450 nm. In addition, because the relative visibility is decreased due to the shift of the emission wavelength of the LED toward shorter wavelength, the beam occurring when Tj is 25° C. is further decreased in comparison with a conventional LED.

However, the LED according to the present embodiment is structured such that the peak wavelength of the light emitted by an LED is shifted toward 450 nm, which is the peak wavelength of the excitation spectrum for a phosphor, as Tj of the LED is raised due to an operation thereof. Therefore, the emission intensity of a phosphor is improved as the temperature of the LED is raised due to an operation thereof. Further, the relative visibility is improved by the shift of the wavelength of the blue light emitted by the LED toward longer wavelength, thereby the beam also exhibiting an increasing tendency.

FIG. 9 is a graph illustrating changes in the brightness relative to time from the start of lighting, in the light emitting module according to the present embodiment. As illustrated in FIG. 9, because the temperature dependence of a phosphor is large, the beam is decreased collectively. However, in the light emitting module according to the present embodiment, a change in the beam from immediately after lighting until the junction temperature is stabilized (approximately 10%-decrease) is reduced to half in comparison with the change in beam illustrated in FIG. 4 (approximately 20%-decrease). Thus, even if a change in the junction temperature occurs, a change in the luminous intensity can be suppressed as compared with a conventional light emitting module. As a result, a change in the luminous intensity between immediately after lighting and in the thermal saturation state in a vehicle can be suppressed, thereby allowing a lamp satisfying a light-distribution specification to be easily designed.

According to the present embodiment, a change in the brightness in an light emitting module or an automotive lamp during lighting can be suppressed.

The present invention has been described above with reference to the aforementioned embodiments. However, the present invention shall not be limited to the above embodiments, but variations in which the structures of the respective embodiments are appropriately combined or replaced, are also within the scope of the present invention. The combinations or the orders of the processes in the embodiments could be appropriately changed, or various modifications such as design modification could be made to the embodiments, based on the knowledge of a skilled person. Such modifications could be also within the scope of the present invention.

What is claimed is:

1. A light emitting module comprising:
a light emitting element; and
a phosphor configured to emit visible light after being excited with the light emitted by the light emitting element, wherein the light emitting element is structured such that the peak wavelength of the light, emitted by the light emitting element immediately after the start of an operation of the light emitting element, is shorter than that of an excitation spectrum for the phosphor, and the peak wavelength of the light emitted by the light emitting element is shifted toward that of the excitation spectrum for the phosphor with an increase in the temperature of the element due to its operation.

2. The light emitting module according to claim 1, wherein the light emitting element is a light emitting diode in which, when the temperature of the light emitting element is in a steady state due to a continuous operation, the peak wavelength of the light emitted by the light emitting element is structured so as to match that of the excitation spectrum for the phosphor.

3. The light emitting module according to claim 1, wherein the light emitting module is a light emitting diode emitting blue light, and wherein the phosphor is a yellow phosphor whose excitation spectrum contains the peak wavelength of the blue light.

4. The light emitting module according to claim 2, wherein the light emitting element is a light emitting diode emitting blue light, and wherein the phosphor is a yellow phosphor whose excitation spectrum contains the peak wavelength of the blue light.

5. An automotive lamp comprising:
the light emitting module according to claim 1; and
a radiating member in which the light emitting module is to be mounted.
